(19) United States
(12) Patent Application Publication
(10) Pub. No.: US 2024/0172894 A1
(43) Pub. Date: May 30, 2024

(54) SYSTEMS AND METHOD FOR PROVIDING AUTOMATIC IGNITION OF A FUEL SOURCE WITHIN A GRILL

(71) Applicant: Premier Specialty Brands LLC, Chamblee, GA (US)

(72) Inventors: Daniel MERCER, Hamilton, GA (US); Will VAN GELDERAN, Atlanta, GA (US); Anthony HARDY, Columbus, GA (US)

(73) Assignee: Premier Specialty Brands LLC, Chamblee, GA (US)

(21) Appl. No.: 18/521,398

(22) Filed: Nov. 28, 2023

Related U.S. Application Data
(60) Provisional application No. 63/428,870, filed on Nov. 30, 2022.

(51) Int. Cl. A47J 37/07; F23Q 7/02

(52) U.S. Cl. CPC A47J 37/079; F23Q 7/02

(57) ABSTRACT

Systems and methods for automatically igniting fuel within a fuel source hopper of a grill are disclosed. In one form, a fire starter tray of a fuel source hopper is positioned beneath a stack of fuel, wherein when a starter block of the fire starter tray is ignited, the starter block ignites the stack of fuel. A heating element of the fuel source hopper is configured to ignite the starter block and a fan of the fuel source hopper is configured to provide an airflow to an area beneath the stack of fuel where the starter block ignites the stack of fuel. A controller in communication with display and user controls and the heating element and the fan is configured to operate the heating element and the fan to automatically ignite the stack of fuel based on information received from the user via the display and user controls.

### RELATED APPLICATIONS

The present application claim priority to U.S. Provisional Patent Application No. 63/428,870, filed Nov. 30, 2022, the entirety of which is hereby incorporated by reference.

### BACKGROUND

Charcoal burning grills may include a charcoal hopper that holds a stack of charcoal in preparation for use. Within the charcoal hopper, a fire is ignited at a bottom of the stack of charcoal. As the charcoal at the bottom of the stack burns, gravity feeds more charcoal from the stack to the fire. One example of a charcoal hopper of this type is disclosed in U.S. patent application Ser. No. 16/535,826, filed Aug. 8, 2019, the entirety of which is incorporated by reference. To increase ease of use, improved methods for igniting a stack of charcoal within a charcoal hopper of a grill are desirable.

### SUMMARY

The present disclosure addresses this problem by providing a system that is able to automatically control components of a fuel source hopper such as a charcoal hopper based on commands provided by a user.

In one implementation, the present disclosure provides a method for automatically igniting fuel within a fuel source hopper of a grill. In the method, a controller receives an indication from a user to initiate an ignition sequence. The controller operates, based on the indication from the user, a heating element of the fuel source hopper to be active for a defined period of time, wherein the heating element is configured to ignite a starter block within the fuel source hopper that is positioned to ignite fuel within the fuel source hopper. Additionally, the controller operates, based on the indication from the user, a fan of the fuel source hopper that is configured to provide an airflow to an area where the starter block ignites fuel within the fuel source hopper.

In another implementation, the present disclosure provides a system for automatically igniting fuel within a fuel source hopper of a grill that comprises a fuel source hopper, a display and user controls, and a controller.

The fuel source hopper includes a basket, a first starter tray, a heating element, and a fan. The basket is configured to hold a stack of fuel. The fire starter tray is positioned beneath the stack of fuel within the fuel source hopper and is configured to hold a starter block. When the starter block is ignited, the positioning of the starter block within the fire starter tray is configured to ignite the stack of fuel in the basket.

The heating element is configured to ignite the starter block within the fire starter tray when the heating element is activated. The fan is configured to provide an airflow to an area beneath the stack of fuel where the starter block in the fire starter tray ignites the stack of fuel in the basket.

The display and user controls is configured to receive information from a user. The controller is in communication with the display and user controls and in communication with the heating element and the fan of the fuel source hopper. Further, the controller is configured to operate the heating element and the fan to automatically ignite the stack of fuel within the fuel source hopper based on information received from the user via the display and user controls.

In yet another implementation, the present disclosure provides a system for automatically igniting charcoal within a charcoal hopper of a grill. The system comprises a charcoal hopper, a display and user controls, and a controller.

The charcoal hopper includes a basket, a first starter tray, a hot surface igniter, and a fan. The basket is configured to hold a stack of charcoal. The fire starter tray is positioned beneath the stack of charcoal within the charcoal hopper and is configured to hold a starter block. When the starter block is ignited, the positioning of the starter block within the fire starter tray is configured to ignite the stack of charcoal in the basket.

The hot surface igniter is configured to ignite the starter block within the fire starter tray when the hot surface igniter is activated. The fan is configured to provide an airflow to an area beneath the stack of charcoal where the starter block in the fire starter tray ignites the stack of fuel in the basket.

The display and user controls are configured to receive information from a user.

The controller is in communication with the display and user controls and in communication with the heating element and the fan of the fuel source hopper. Further, the controller is configured to: receive, via the display and user controls, an indication from the user to initiate an ignition sequence and a desired temperature; control the heating element of the charcoal hopper to be active for a defined period of time based on the indication from the user; and control the fan of the charcoal hopper, based on the indication from the user, to provide the airflow to the area beneath the stack of charcoal where the starter block in the fire starter tray ignites the stack of charcoal in the basket.

### BRIEF DESCRIPTION OF THE DRAWINGS

FIG. 1 is a block diagram illustrating one form of a system for providing automatic ignition of a fuel source.

FIG. 2 is an illustration of a grill including one form of a system for providing automatic ignition of a fuel source.

FIG. 3 is an illustration of a fuel source hopper coupled with components of a grill.

FIG. 4 is a front view of internal components of a portion of the fuel source hopper of FIG. 3.

FIG. 5 illustrates a lid of the fuel source hopper that is configured to provide a cooking surface.

FIG. 6 is a flow chart of one form of a method for automatic ignition of a fuel source within a fuel source hopper of a grill.

### DETAILED DESCRIPTION

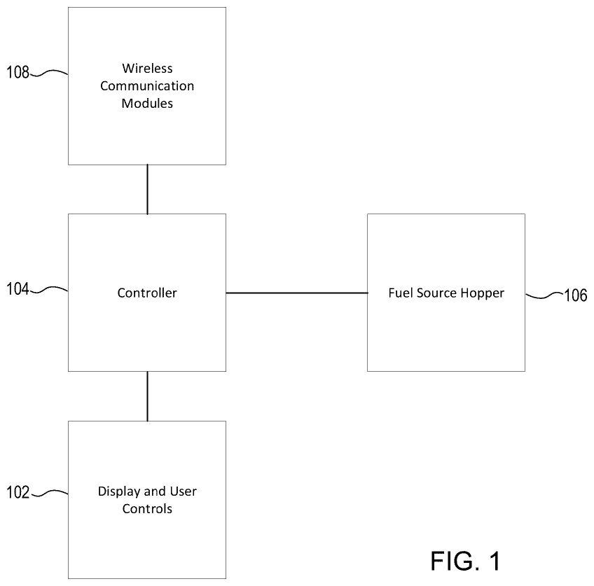

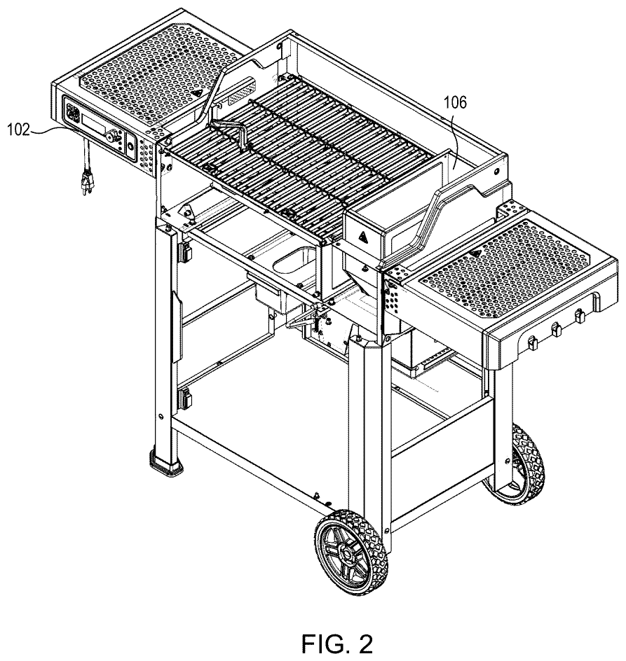

The present disclosure provides systems and methods for providing automatic ignition of a fuel source within a grill. FIG. 1 is a block diagram illustrating one form of a system for providing automatic ignition of a fuel source and FIG. 2 is an illustration of a grill including a system for providing automatic ignition of a fuel source. The system may include a display and user controls 102, a controller 104, and a fuel source hopper 106. The display and user controls 102 may include a display, a touch screen, knobs, buttons, lights, and/or any other type of type of means for a user to input information and have information provided to the user.

The display and user controls 2 are in electrical communication with the controller 104. The controller 104 may be a hardwired controller; a processor executing instructions stored in a memory; processing circuitry; or any other types of hardware configured to execute instructions that may be stored in a memory and perform operations as disclosed in the present application. In some implementations, the controller 104 may be in communication with one or more wireless communication modules 108 for wireless communications over protocols such as WiFi or Bluetooth. The controller 104 may additionally be in communication with components of the fuel source hopper 106, as described below.

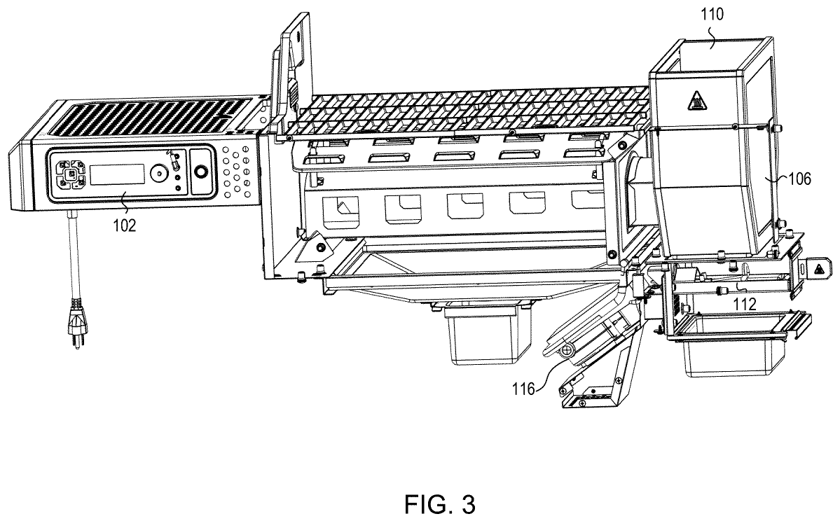

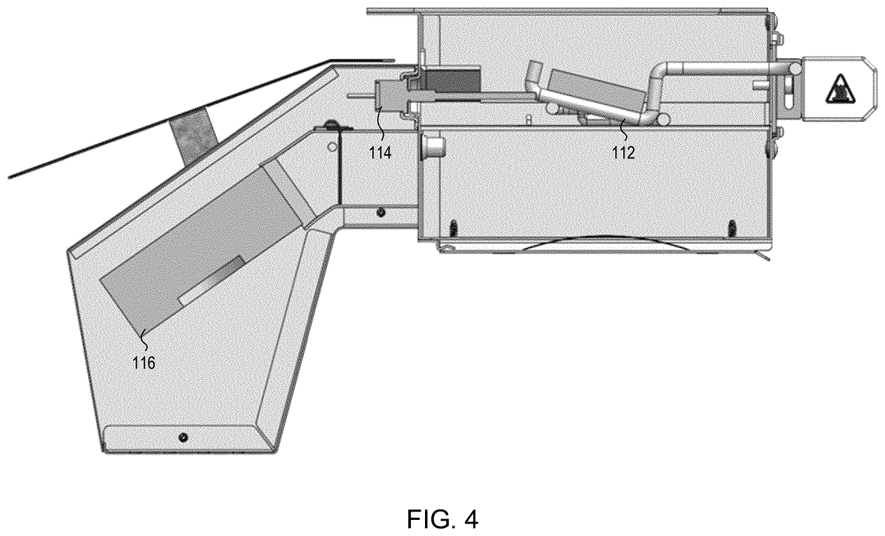

One implementation of a fuel source hopper 106 is shown in FIGS. 3 and 4. FIG. 3 is an illustration of a fuel source hopper coupled with components of a grill and FIG. 4 is a front view of internal components of a portion of the fuel source hopper of FIG. 3.

The fuel source hopper 106 may include a basket area 110, a fire starter tray 112, a heating element such as a hot surface igniter 114, and a fan 116. In some implementations, the fuel source hopper 106 and its components may be made of steel with porcelain coating. However, in other implementations, other materials may be used. Additionally, in some implementations, the fuel source hopper 106, or a portion of the fuel source hopper 106 such as the basket area 110, may be configured to be removable from a grill for cleaning or replacement.

The basket area 110 of the fuel source hopper 106 is configured to hold a fuel such as charcoal in a stack. A bottom of the basket area 110 is generally open to allow the stack of charcoal to be lit and burn at its bottom. Due to a vertical nature of the stack of charcoal, as the bottom of the stack burns, gravity continues to feed the fire with charcoal.

The fire starter tray 112 is configured to hold a starter block that may be configured in a tumble weed style or a compressed wood style and is configured to slide between a position under the basket area 110 to a position away from underneath the basket area 110 that allows a user to place the starter block in the fire starter tray 112. When the fire starter tray 112 is positioned under the basket area 110, the starter block in the fire starter tray 112 may be ignited. As the starter block burns in the fire starter tray 112, the fire from the starter block ignites the fuel such as charcoal in the basket area 110.

When the fire starter tray 112 is positioned under the basket area 110, the fire starter tray 112 engages the hot surface igniter 114. The hot surface igniter 114 is in communication with the controller 104 to allow the controller to turn the hot surface igniter 114 on or off. When the hot surface igniter 114 is turned on, the hot surface igniter 114 ignites the starter block positioned in the fire starter tray 112, which additionally starts a fire in the fuel such as charcoal in the basket area 110.

When turned on, the fan 116 draws air from outside the fuel source hopper 106 and provides an airflow to an area including the bottom of basket area 110, the first starter tray 112, and the hot surface igniter 114. It will be appreciated that the airflow assists the lit starter block to ignite the fuel at the bottom of the basket area 110, and that once the fuel at the bottom of the basket area 110 is lit, assists the fuel at the bottom of the basket area 110 to continue to burn. The fan 116 is additionally in communication with the controller 104 to allow the controller 104 to turn the fan on and off and to operate the fan at various speeds or power levels.

It will be appreciated that once the fuel in the fuel hopper is ignited as described above, the burning fuel generates heated air, smoke, and/or flames that flows from the fuel source hopper 106 and into a manifold that distributes heat within a cooking area of the grill. Accordingly, the system is able to provide more ease of use to a user in igniting a fuel source of a grill.

In some implementations, the fuel source hopper 106 is sized to be positioned inside of a lid of the grill, as shown in FIG. 2. However, in other implementations, the fuel source hopper 106 may be larger in size to accommodate a larger stack of fuel and be positioned outside of the lid of the grill.

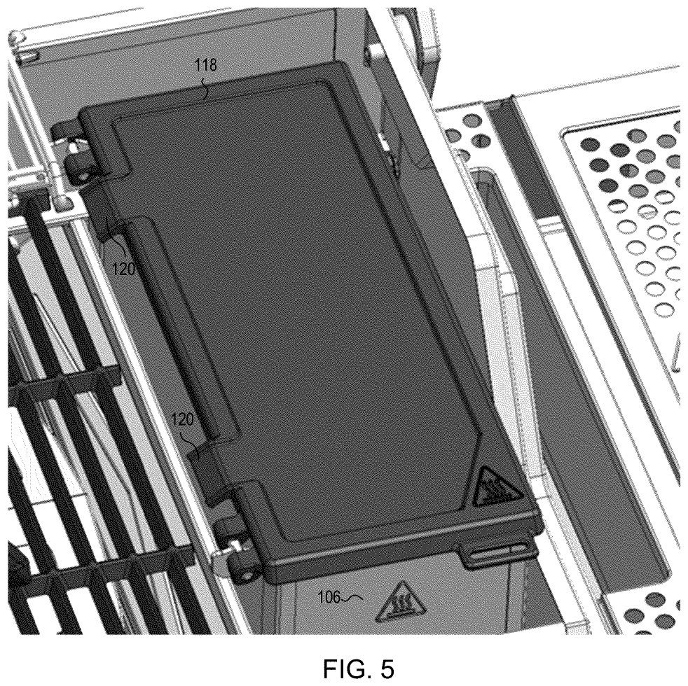

Further, referring to FIG. 5, in some implementations, the fuel source hopper 106 may include a lid 118 that may be utilized for preparing food. In particular, the lid 118 may define a cooking surface that may be utilized to sear food without adjusting a temperature of the grill. It will be appreciated that because the cooking surface of the lid 118 is position above the stack of fuel that is burning with the fuel source hopper 106, the cooking surface of the lid 118 is heated from underneath.

To assist in grease management, in some implementations, the lid 118 may include a recessed center area that is configured to restrict the flow of grease on the lid 118. Additionally, in some implementations, the lid 118 may define one or more recessed channels 120 that direct grease from the surface of the lid 118 and into the cooking area of a grill.

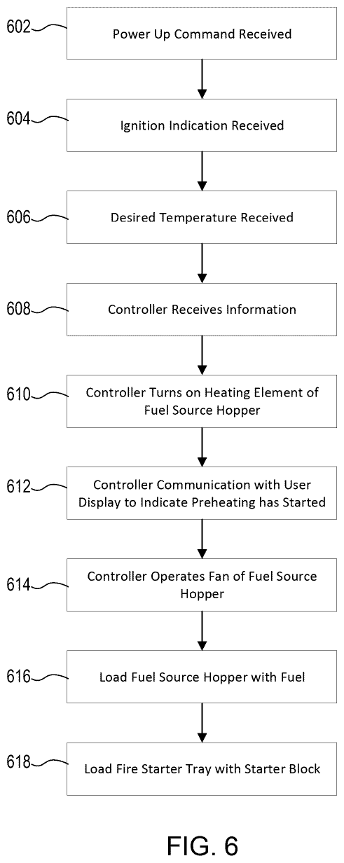

When operating together, the display and user controls 102, the controller 104, and the fuel source hopper 106 are able to provide an automatic method for igniting the fuel source within the fuel source hopper 106. FIG. 6 is a flow chart of one form of a method for automatically igniting a fuel source within a grill.

At step 602, a user interacts with the display and user controls to power up the grill. In some implementations, this may include a user pressing a dedicated power button on the display and user controls.

At step 604, the user interacts with the display and user controls to initiate an ignition sequence. In some implementations, this may include a user pressing a dedicated ignite button on the display and user controls.

At step 606, the user interacts with the display and user controls to set a desired temperature. In some implementations, this may include a user turning a knob or pressing a series of buttons while a desired temperature is displayed on a display and then pressing a dedicated set temperature button on the display and user controls.

At step 608, the controller receives information from the display and user controls as the user interacts with the controls to provide information in steps 602, 604, and 606. However, it will be appreciated that in other implementations, the controller may receive information such as that provided in one or more of steps 602, 604, and 606 through wireless communications via one or more wireless modules in communication with the controller. In these implementations, a user may interact with a dedicated application or web-based applications running on a mobile device to communicate information to the controller and power up the grill, initiate an ignition sequence, and/or provide a desired temperature. Examples of mobile devices where a user may interact with a dedicated application or web-based applications may include a cellular phone, a tablet computer, or a personal computer.

At step 610, the controller communicates with the heating element such as the hot surface igniter of the fuel source hopper to turn the hot surface igniter on for a period of time. In some implementations, the controller may turn the hot surface igniter on for four minutes. However, other periods of time could be used.

At step 612, the controller communicates with the display and user controls to provide an indication to the user that preheating has started. In some implementations, this may include illuminating a light on the display and user controls. Further, in some implementations, this may include illuminating a light in a pattern, such as flashing a light for a first period of time and then illuminating the light in a solid manner for a second period of time.

At step 614, the controller communicates with the fan of the fuel source hopper to start the fan and control a power level of the fan for different periods of time. For example, in some implementations, the controller may start the fan of the fuel source hopper and run the fan at 10% power for approximately three minutes. After this period of time, the controller will increase the speed of the fan to run at 35% for approximately five minutes, and then afterwards, increase the speed of the fan to run at 100% for eight minutes or more.

In some implementations, the controller may adjust a power level of the fan and a period of time that the fan is operated based in part on the desired temperature provided in step 606 and a measured temperature inside the grill. However, in other implementations, the controller may utilize a default temperature to set a power level of the fan and a period of time that the fan is operated when, for example, a user initiates ignition of the grill but does not provide a desired temperature.

Before, after, or during the above-recited steps, the user may also perform a number of steps to prepare the grill in preparation of the automatic ignition of the fuel source within the fuel source hopper.

For example, at step 616, the user may load the fuel source hopper with fuel such as charcoal and close the fuel source hopper lid and the grill lid. Additionally, at step 618, the user may open the fire starter tray, place a starter block in the fire starter tray, and slide the fire starter tray to position such that the starter block is positioned under the stack of fuel and is engaged with the hot surface igniter.

As described above, the disclosed systems and methods provide automatic ignition of a fuel source within a grill. A controller within a system is able to receive information from a user and automatically control components of a fuel source hopper such as a charcoal hopper to automatically ignite a starting block to ignite a stack of fuel and to provide an airflow to assist in the ignition of stack of fuel and provide an airflow to a burning stack of fuel, thereby increasing ease of use.

Although certain embodiments and implementations of the disclosure have been specifically described herein, it will be apparent to those skilled in the art to which the disclosure pertains that variations and modifications of the various embodiments shown and described herein may be made without departing from the spirit and scope of the disclosure. Accordingly, it is intended that the disclosure be limited only to the extent required by the appended claims and the applicable rules of law.

1. A method for automatically igniting fuel within a fuel source hopper of a grill, the method comprising:
receiving, with a controller, an indication from a user to initiate an ignition sequence;
controlling, with the controller, based on the indication from the user, a heating element of the fuel source hopper to be active for a defined period of time, wherein the heating element is configured to ignite a starter block within the fuel source hopper that is positioned to ignite fuel within the fuel source hopper; and
controlling, with the processor, based on the indication from the user, a fan of the fuel source hopper that is configured to provide an airflow to an area where the starter block ignites fuel within the fuel source hopper.

2. The method of claim 1, wherein controlling the fan of the fuel source hopper comprises:
controlling, with the controller, the fan to run at a first power level for a first period of time; and
controlling, with the controller, the fan to run at a second power level for a second period of time;
wherein the second period of time occurs after expiration of the first period of time and the first power level is different than the second power level.

3. The method of claim 1, wherein the fuel within the hopper comprises charcoal.

4. The method of claim 1, wherein the heating element comprises a hot surface igniter.

5. The method of claim 1, wherein the starter block is configured in at least one of a tumble weed style configuration or a compressed wood style configuration.

6. A system for automatically igniting fuel within a fuel source hopper of a grill, the system comprising:
a fuel source hopper comprising:
a basket configured to hold a stack of fuel;
a fire starter tray positioned beneath the stack of fuel within the fuel source hopper and configured to hold a starter block, wherein when the starter block is ignited, the positioning of the starter block within the fire starter tray is configured to ignite the stack of fuel in the basket;
a heating element configured to ignite the starter block within the fire starter tray when the heating element is activated; and
a fan configured to provide an airflow to an area beneath the stack of fuel where the starter block in the fire starter tray ignites the stack of fuel in the basket;
a display and user controls configured to receive information from a user; and
a controller in communication with the display and user controls and in communication with the heating element and the fan of the fuel source hopper, wherein the controller is configured to operate the heating element and the fan to automatically ignite the stack of fuel within the fuel source hopper based on information received from the user via the display and user controls.

7. The system of claim 6, wherein the fuel comprises charcoal.

8. The system of claim 6, wherein the starter block is configured in at least one of a tumble weed style configuration or a compressed wood style configuration.

9. The system of claim 6, wherein the fire starter tray is configured to move between at least two positions, wherein in a first position the fire starter tray is positioned underneath the stack of fuel and in a second position the fire starter tray is positioned away from the stack of fuel and accessible to the user to place the starter block in the fire starter tray.

10. The system of claim 6, wherein to operate the heating element and the fan to automatically ignite the fuel within the fuel source hopper based on information received from the user and the display and user controls, the controller is configured to:
receive, via the display and user controls, an indication from the user to initiate an ignition sequence;
receive, via the display and user controls, an indication from the user of a desired temperature;
control the heating element of the fuel source hopper to be active for a defined period of time; and
control the fan of the fuel source hopper to provide the airflow to the area beneath the stack of fuel where the starter block in the fire starter tray ignites the stack of fuel in the basket.

11. The system of claim 10, wherein to control the fan of the fuel source hopper, the controller is configured to:
control the fan to run at a first power level for a first period of time; and
control the fan to run at a second power level for a second period of time;
wherein the second period of time occurs after expiration of the first period of time and the first power level is different than the second power level.

12. The system of claim 6, wherein the fuel source hopper is removable from the grill.

13. The system of claim 6, wherein the fuel source hopper further comprises:
a lid positioned in the fuel source hopper above the basket, the lid configurated to provide a cooking surface that is heated underneath from burning of the stack of fuel within the basket.

14. The system of claim 13, wherein the lid defines a recess configured to restrain the flow of grease.

15. The system of claim 14, wherein the lid further defines at least one recessed channel configured to direct grease from the lid and into a cooking area of the grill.

16. A system for automatically igniting charcoal within a charcoal hopper of a grill, the system comprising:
a charcoal hopper comprising:
a basket configured to hold a stack of charcoal;
a fire starter tray positioned beneath the stack of charcoal within the charcoal hopper and configured to hold a starter block, wherein when the starter block is ignited, the positioning of the starter block within the fire starter tray is configured to ignite the stack of charcoal in the basket;
a hot surface igniter configured to ignite the starter block within the fire starter tray when the hot surface igniter is activated; and
a fan configured to provide an airflow to an area beneath the stack of charcoal where the starter block in the fire starter tray ignites the stack of fuel in the basket;
a display and user controls configured to receive information from a user; and
a controller in communication with the display and user controls and in communication with the heating element and the fan of the fuel source hopper, wherein the controller is configured to:
receive, via the display and user controls, an indication from the user to initiate an ignition sequence and a desired temperature;
control the heating element of the charcoal hopper to be active for a defined period of time based on the indication from the user; and
control the fan of the charcoal hopper, based on the indication from the user, to provide the airflow to the area beneath the stack of charcoal where the starter block in the fire starter tray ignites the stack of charcoal in the basket.

17. The system of claim 16, wherein the charcoal hopper further comprises:
a lid positioned in the charcoal hopper above the basket, the lid configurated to provide a cooking surface that is heated underneath from burning of the stack of charcoal within the basket.

18. The system of claim 17, wherein the lid defines a recess configured to restrain the flow of grease.

19. The system of claim 18, wherein the lid further defines at least one recessed channel configured to direct grease from the lid and into a cooking area of the grill.

20. The system of claim 16, wherein the charcoal hopper is removable from the grill.
